(19) United States
(12) Patent Application Publication
(10) Pub. No.: US 2015/0197437 A1
(43) Pub. Date: Jul. 16, 2015

(54) Chemical Feeder

(71) Applicant: Axiall Ohio, Inc., Atlanta, GA (US)

(72) Inventor: Richard H. Ferguson, Cecil, PA (US)

(21) Appl. No.: 14/571,320

(22) Filed: Dec. 16, 2014

Related U.S. Application Data
(60) Provisional application No. 61/925,714, filed on Jan. 10, 2014.

(51) Int. Cl. C02F 1/68; B01F 1/00; B01F 5/04; C02F 1/50; C02F 1/66

(52) U.S. Cl. CPC C02F 1/688; C02F 1/50; C02F 1/66; B01F 5/0496; B01F 1/0027; B01F 1/0005; C02F 2103/42

(57) ABSTRACT

The present invention relates to a chemical feeder that includes a container (11) having an open container end (20) that is attached to the second surface (38) of a lid (32), and a housing (50) having an upper portion that is attached to the first surface (35) of the lid. The housing includes a perforated support plate (77) and a nozzle (92) having a distributor head (95) that extends up through a first support plate opening (86) and a first lid opening (41). The distributor head includes at least one distributor head aperture (101) that resides above second surface (35) of the lid, and which distributes a feed liquid laterally into the container chamber (23) where it contacts a solid chemical material (47) and forms a treated liquid, which is removed from the chemical feed through a housing outlet (110). Methods of forming a treated liquid are also provided.

### CROSS REFERENCE TO RELATED APPLICATION

The present application is entitled to and claims priority of U.S. Provisional Patent Application No. 61/925,714, filed on Jan. 10, 2014, the disclosure of which is incorporated herein by reference in its entirety.

### FIELD

The present invention relates to a chemical feeder that includes a container in which solid chemical material is contained, a lid that includes first and second lid openings, which is attached to an open end of the container and to an open end of a housing that includes a support plate having first and second support plate openings and a nozzle having a distributor head that extends up through the first support plate opening and the first lid opening, in which the distributor head is adapted to distribute a feed liquid laterally into the container so as to form a treated liquid that is removed from the chemical feeder through a housing outlet.

### BACKGROUND

Chemical feeders can be used to produce various mixtures, such as aqueous solutions of water treating agents that can be used, for example, for the disinfection of effluent from sewage treatment plants, for the chlorination of water in swimming pools and hot tubs, and for the delivery of other water soluble chemicals to aqueous streams and water systems. In some instances, a solid treatment chemical is placed within the chemical feeder, where it comes into contact with a liquid, such as water, introduced therein so as to form a treated liquid composition, such as a treated aqueous composition.

Minimizing the exposure of people, such as equipment operators, to some solid treatment chemicals used in chemical feeders is desirable in some situations for reasons of health and safety. The amount of solid treatment chemicals added to a chemical feeder can be subject to human error, which can result in the formation of a treated liquid that contains too little or too much dissolved treatment chemicals. As such, the design of new chemical feeders that minimize or eliminate the need for people to come into direct contact with the solid treatment chemicals contained therein would be desirable. It would be further desirable that such newly developed chemical feeders can be pre-loaded with pre-selected amounts of solid treatment chemicals under controlled and reproducible conditions, such as within a manufacturing facility.

### SUMMARY

In accordance with the present invention, there is provided a chemical feeder that comprises: (a) a container comprising a container base, and a container sidewall extending downward from the container base, the container sidewall defining an open container end, the container base and the container sidewall together defining a container chamber; (b) a lid attached to the open container end, the lid having a first surface, a second surface, a first lid opening, and a plurality of second lid openings, the lid being adapted to support a solid chemical material on and above the second surface of the lid and within the container chamber; and (c) a housing comprising a housing base, and a housing sidewall extending upward from the housing base, the housing sidewall defining an open housing end, and the housing base and the housing sidewall together defining a housing chamber, wherein an upper portion of the housing sidewall is adapted to mate with a section of the first surface of said lid. The housing of the chemical feeder further comprises, a support plate comprising a first support plate opening and a plurality of second support plate openings, the support plate residing within the housing chamber and being positioned above an interior surface of the housing base and below the first surface of the lid. The housing of the chemical feeder further comprises, a nozzle that resides within the housing chamber, the nozzle comprising a distributor head comprising a distributor head sidewall comprising at least one distributor head aperture, wherein the distributor head extends through the first support plate opening and the first lid opening, and each distributor head aperture is positioned above the second surface of the lid and in fluid communication with the container chamber, each distributor head aperture being adapted to distribute a feed liquid laterally into the container chamber. The housing additionally comprises, a housing inlet through which the feed liquid is introduced into the chemical feeder, the housing inlet being in fluid communication with the nozzle, wherein the plurality of second lid openings provide fluid communication between the container chamber and the housing chamber. The housing further additionally comprises, a housing outlet that is in fluid communication with the housing chamber and through which the treated liquid comprising dissolved chemical material is removed from the housing (and correspondingly, from the chemical feeder).

The present invention also relates to a method of forming a treated liquid comprising dissolved chemical material, which comprises: (a) providing the chemical feeder as described above; (b) introducing a feed liquid into the housing inlet, wherein the feed liquid passes through the nozzle and laterally outward through each distributor head aperture into the container chamber where it contacts the solid chemical material, thereby forming the treated liquid comprising dissolved chemical material; (c) allowing the treated liquid comprising dissolved chemical material to pass from the container chamber through the plurality of second lid apertures and into the housing chamber; and (d) removing, from the housing, the treated liquid comprising dissolved chemical material through the housing outlet.

The present invention further relates to a method of forming a treated liquid comprising dissolved chemical material that comprises first assembling the chemical feeder as described above, which method comprises: (a) providing a container comprising a container base, and a container sidewall extending upward from the container base, the container sidewall defining an open container end, the container base and the container sidewall together defining a container chamber in which a solid chemical material is housed, the container further comprising a lid attached to the open container end, the lid having a first surface, a second surface, a first lid opening, and a plurality of second lid openings, the lid being adapted to support the solid chemical material on and above the second surface of the lid and within the container chamber; and (b) providing a housing comprising a housing base, and a housing sidewall extending upward from the housing base, the housing sidewall defining an open housing end, and the housing base and the housing sidewall together defining a housing chamber, wherein an upper portion of the housing sidewall is adapted to mate with a section of the first surface of the lid. The housing further comprises: (i) a support plate comprising a first support plate opening and a plurality of second support plate openings, the support plate residing within the housing chamber and being positioned above an interior surface of the housing bass; (ii) a nozzle that resides within the housing chamber, the nozzle comprising a distributor head comprising a distributor head sidewall comprising at least one distributor head aperture; (iii) a housing inlet that is in fluid communication with the nozzle; and (iv) a housing outlet that is in fluid communication with the housing chamber. The method further comprises, (c) inverting the container and mounting the upper portion of the housing sidewall and the section of the first surface of the lid together, such that the distributor head extends through the first support plate opening and the first lid opening, and each distributor head aperture is positioned above the second surface of the lid and in fluid communication with the container chamber, each distributor head aperture being adapted to distribute a feed liquid laterally into the container chamber, wherein the support plate is positioned below the first surface of the lid, and wherein the plurality of second lid openings provide fluid communication between the container chamber and the housing chamber. The method further comprises, (d) introducing the feed liquid into the housing inlet, wherein the feed liquid passes through the nozzle and laterally outward through each distributor head aperture into the container chamber where it contacts the solid chemical material, thereby forming the treated liquid comprising dissolved chemical material; (e) allowing the treated liquid comprising dissolved chemical material to pass from the container chamber through the plurality of second lid apertures and into the housing chamber; and (f) removing, from the housing, the treated liquid comprising dissolved chemical material through the housing outlet.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### BRIEF DESCRIPTION OF THE DRAWINGS

FIG. 1(a) is a representative partially exploded side elevational partial sectional view of a chemical feeder in accordance with some embodiments of the present invention;

FIG. 1(b) is a representative assembled side elevational partial sectional view of the chemical feeder of FIG. 1(a);

FIG. 2 is a representative top plan view of a lid of a chemical feeder according to some embodiments of the present invention;

FIG. 3 is a representative top plan view of a support plate of a chemical feeder according to some embodiments of the present invention;

FIG. 4 is a representative side elevational partial sectional view of a distributor head of a nozzle according to some embodiments of the present invention;

FIG. 5 is a representative top plan sectional view of a distributor head according to some embodiments of the present invention that includes tangential distributor head apertures;

FIG. 6(a) is a representative perspective view of the first surface of a lid of a chemical feeder according to some embodiments of the present invention;

FIG. 6(b) is a representative perspective view of the second surface of the lid of FIG. 6(b);

FIG. 7 is a representative side elevational partial sectional view of a portion of a housing of a chemical feeder according to some embodiments of the present invention that includes a support plate ledge upon which the support plate is at least partially supported;

FIG. 8 is a representative partially exploded side elevational partial sectional view of a portion of the chemical feeder of FIG. 1(a) focusing on a portion of the container sidewall, lid, and housing sidewall; and

FIG. 9 is a representative exploded perspective view of the lid of FIG. 6(a), which further includes lid opening closures and a lid cover.

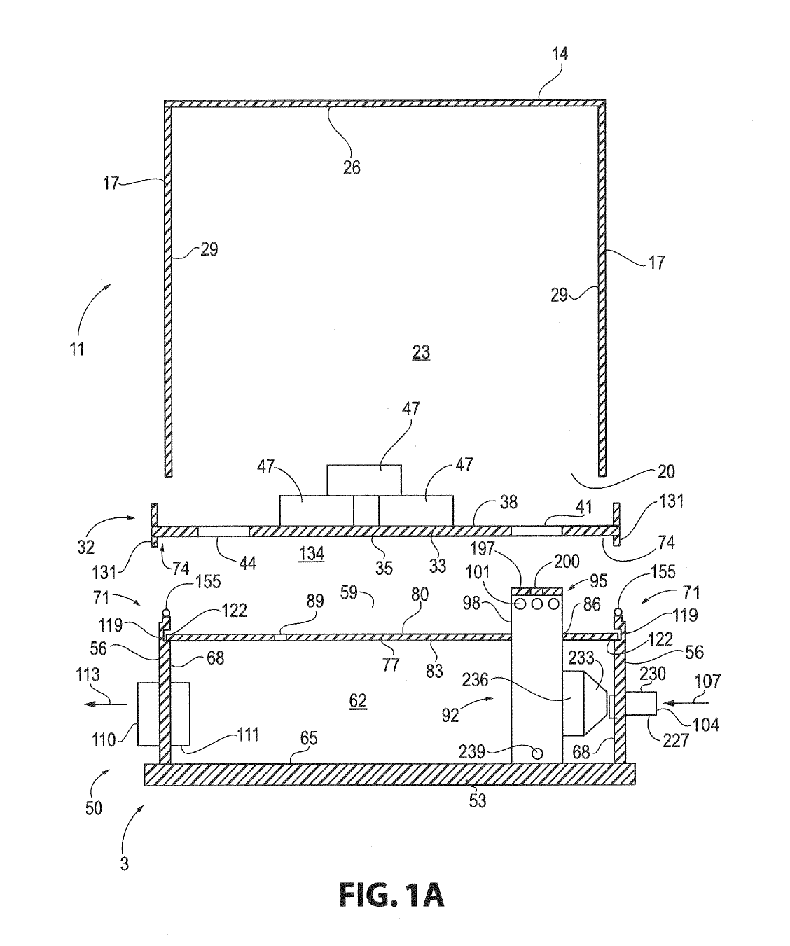

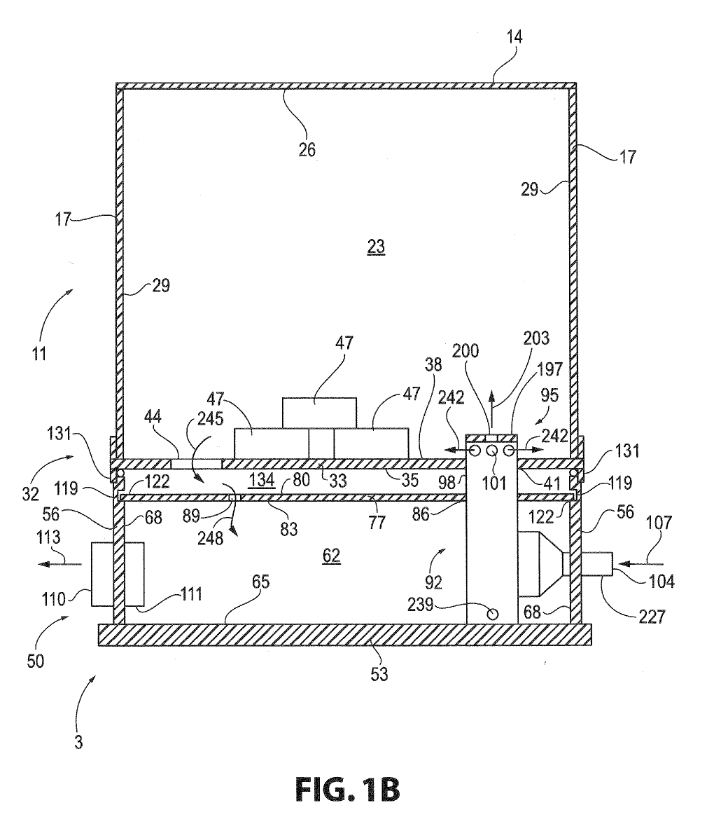

In FIGS. 1(a) through 9 like characters refer to the same components and/or streams, such as liquid streams, as the case may be, unless otherwise stated.

### DETAILED DESCRIPTION

As used herein, the singular articles “a,” “an,” and “the” include plural referents unless otherwise expressly and unequivocally limited to one referent.

Unless otherwise indicated, all ranges or ratios disclosed herein are to be understood to encompass any and all subranges or subratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 6.1, 3.5 to 7.8, and 5.5 to 10.

Unless otherwise indicated, all numbers expressing dimensions, quantities of ingredients, flow rates, pressures, and so forth used in the specification and claims are to be understood as modified in all instances by the term “about.”

All documents, such as but not limited to issued patents and patent applications, referred to herein, and unless otherwise indicated, are to be considered to be “incorporated by reference” in their entirety.

As used herein, spatial or directional terms, such as “left”, “right”, “inner”, “outer”, “above”, “below”, “vertically”, “upward”, and the like, relate to embodiments of the invention as depicted in the drawing figures. However, it is to be understood that the invention can assume various alternative orientations and, accordingly, such terms are not to be considered as limiting.

With reference to FIG. 1(a) and FIG. 1(b) of the drawings, there is depicted a chemical feeder 3 according to some embodiments of the present invention. Chemical feeder 3 includes a container 11 that includes a container base 14 and a container sidewall 17 that extends away from, such as downward from, container base 14. Depending on the orientation of container 11, sidewall 17 can extend downward or extend upward from container base 14, with some embodiments. When the chemical feed is assembled, sidewall 17 extends downward from container base 14, with some embodiments. Container sidewall 17 defines an open container end 20. Container base 14 and container sidewall 17 together define a container chamber 23. More particularly, and with some embodiments, inner surface 26 of container base 14 and inner surface 29 of container sidewall 17 together define container chamber 23.

The container of the chemical feeder includes a container sidewall, such as container sidewall 17. As used herein the term “container sidewall” includes singular and plural referents thereof. As such, the container of the chemical feeder of the present invention can include a single container sidewall or a plurality of container sidewalls. With some embodiments, container sidewall 17 is a unitary sidewall (or unitary sidewall structure).

Container 11, with some embodiments, is a substantially cylindrical container. Container 11 can, with some further embodiments, have other shapes including, but not limited to, spherical and multi-sided shapes, such as, square-tubular, recta-tubular, hexa-tubular and octa-tubular. With some embodiments, the shape of container chamber 23 (such as defined by interior surfaces 26 and 29) can be different than the external shape of container sidewall 17 and container base 14. For purposes of non-limiting illustration, the exterior shape of container sidewall 17 can be square, and container base 14 can be square or circular, while interior surfaces 26 and 29 define a substantially cylindrical container chamber 23. With some further embodiments, container sidewall extends away from container base 14 at an angle that is other than 90°, such as greater than 90°, and container sidewall 17 is a conical container sidewall (not shown).

Container base 14 is affixed to container sidewall 17, such as to the bottom of container sidewall 17. With some embodiments, container base 14 is attached to container sidewall 17 by art-recognized reversibly closeable systems, such as, matching threaded sections and/or fasteners (not shown). In accordance with some further embodiments, container base 14 is attached to container sidewall 17 by a substantially permanent system, such as by adhesives and/or welds. With some embodiments, container base 14 and container sidewall 17 together form (or are) a unitary container base-container sidewall structure.

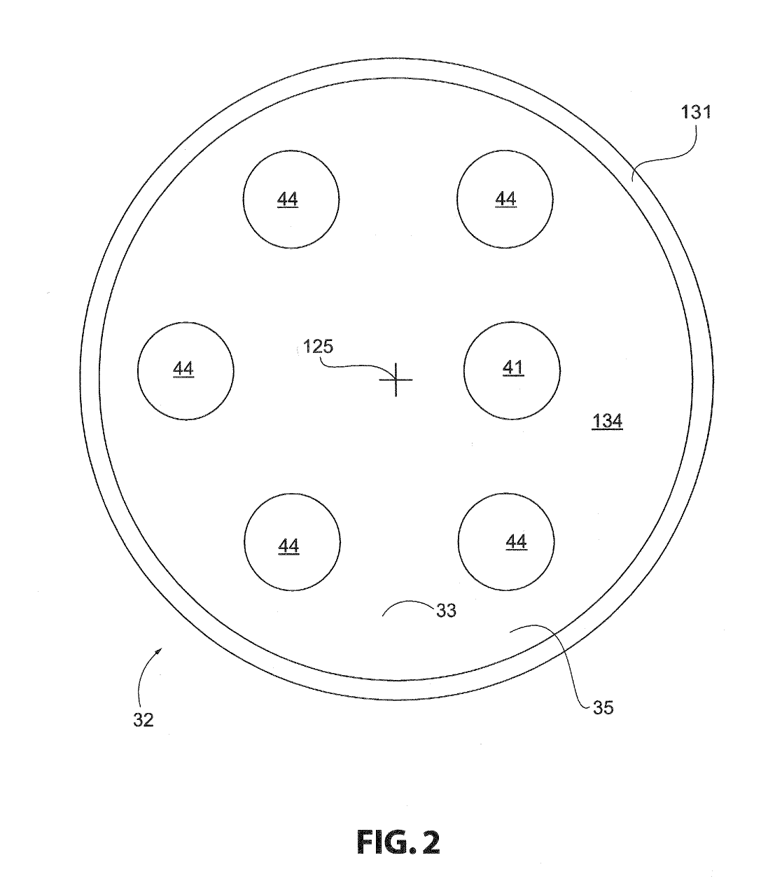

The chemical feeder of the present invention further includes a lid 32, which is attached to open container end 20. With reference to FIGS. 1(a), 1(b), and 2, lid 32 includes a first surface 35, a second surface 38, a first lid opening 41, and a plurality of second lid openings 44. With some embodiments, lid 32 is described as having a lid base 33, and lid base 33 has a first surface 35, a second surface 38, a first lid opening 41, and a plurality of second lid openings 44. For ease of illustration, lid 32 is depicted in FIGS. 1(a) and 1(b) with only one second lid opening 44. Lid 32 (or lid base 33) is adapted to support a solid chemical material 47 on and above second surface 38 of lid 32 and within container chamber 23.

The chemical feeder of the present invention further includes a housing 50, which includes a housing sidewall 56 that extends upward from a housing base 53 thereof. Housing sidewall 56 defines an open housing end 59. Housing base 53 and housing sidewall 56 together define a housing chamber 62. More particularly, and with some embodiments, inner surface 65 of housing base 53 and inner surface 68 of housing sidewall 56 together define housing chamber 62. An upper portion 71 of housing sidewall 56 is adapted to mate with a section 74 (such as a perimeter section 74) of first surface 35 of lid 32 (or section 74 of first surface 35 of lid base 33).

The housing of the chemical feeder includes a housing sidewall, such as housing sidewall 56. As used herein the term “housing sidewall” includes singular and plural referents thereof. As such, the housing of the chemical feeder of the present invention can include a single housing sidewall or a plurality of housing sidewalls. With some embodiments, housing sidewall 17 is a unitary sidewall (or unitary sidewall structure).

Housing 50, with some embodiments, is a substantially cylindrical housing. Housing 50 can, with some further embodiments, have other shapes including, but not limited to, spherical and multi-sided shapes, such as, square-tubular, recta-tubular, hexa-tubular and octa-tubular. With some embodiments, the shape of housing chamber 62 (such as defined by interior surfaces 65 and 68) can be different than the external shape of housing sidewall 56 and housing base 53. For purposes of non-limiting illustration, the exterior shape of housing sidewall 56 can be square, and housing base 53 can be square or circular, while interior surfaces 65 and 68 define a substantially cylindrical housing chamber 62.

With some embodiments of the present invention, the container is a substantially cylindrical container, and the housing is a substantially cylindrical housing. In accordance with some further embodiments, the container chamber is a substantially cylindrical container chamber and the housing chamber is a substantially cylindrical housing chamber.

Housing base 53 is affixed to housing sidewall 56, such as to the bottom of housing sidewall 56. With some embodiments, housing base 53 is attached to housing sidewall 56 by art-recognized reversibly closeable systems, such as, matching threaded sections and/or fasteners (not shown). In accordance with some further embodiments, housing base 53 is attached to housing sidewall 56 by a substantially permanent system, such as by adhesives and/or welds. With some embodiments, housing base 53 and housing sidewall 56 together form (or are) a unitary housing base-housing sidewall structure.

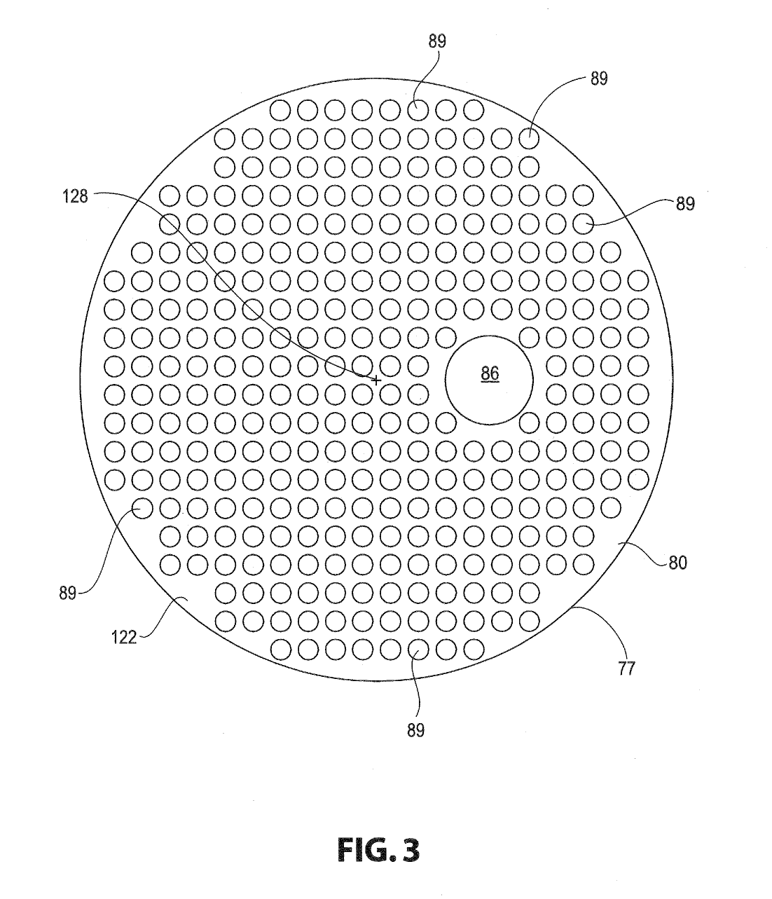

The housing of the chemical feeder of the present further includes, with some embodiments a support plate 77 that has a first surface 80 and a second surface 83. With reference to FIGS. 1(a), 1(b), and 3, support plate 77 further includes a first support plate opening 86 and a plurality of second support plate openings 89. Support plate 77 resides within housing chamber 62 and is positioned above interior surface 65 of housing base 53 and below first surface 35 of lid 32. With some embodiments, first surface 80 of support plate 77 and first surface 35 of lid 32 are in facing and separated opposition to each other, and second surface 83 of support plate 77 and inner surface 65 of housing base 53 are in facing and separated opposition to each other.

The housing of the chemical feeder, with some embodiments, further includes a nozzle 92 that resides within housing chamber 62. Nozzle 92 includes a distributor head 95 that includes a distributor head sidewall 98. Distributor head 98 includes at least one distributor head aperture 101. Distributor head 95 extends through first support plate opening 86 and extends through first lid opening 41. Each distributor head aperture 101 is positioned above second surface 38 of lid 32 and is in fluid communication with container chamber 23. Each distributor head aperture 101 is adapted to distribute a feed liquid laterally into container chamber 23, as indicated by arrows 242 in FIG. 1 (a).

The nozzle of the housing, with some embodiments, extends generally upward relative to the housing base. With some embodiments, nozzle 92 rests on and/or is attached to inner surface 65 of housing base 53, as depicted in FIGS. 1(a) and 1(b). With some further embodiments, the nozzle is suspended above inner surface 65 of housing base 53 (not depicted in the drawings). In accordance with some additional embodiments, the nozzle is attached to inner surface 65 of housing base 53 by one or more support members, such as flanges (not depicted in the drawings).

The housing of the chemical feeder of the present invention further includes, with some embodiments, at least one housing inlet 104 through which a feed liquid is introduced into the chemical feeder, as indicated by arrow 107. Each housing inlet can be independently positioned in any suitable location in the housing, such as the housing base or the housing sidewall. For ease of illustration, a single housing inlet 104 is depicted in the drawings. With some embodiments housing inlet 104 is positioned in and extends through housing sidewall 56 as depicted in the drawings. The plurality of second lid openings 44 provide fluid communication between container chamber 23 and housing chamber 62, with some embodiments.

The housing of the chemical feeder of the present invention further includes, with some embodiments, at least one housing outlet 110 that is in fluid communication with housing chamber 62. In accordance with some embodiments of the present invention, a treated liquid that includes dissolved chemical material is removed from housing chamber 62 of housing 50 (and correspondingly from the chemical feeder) through housing outlet 110, as indicated by arrow 113. The housing outlet (or housing outlets) can each be independently located in any appropriate position in the housing, such as in a housing sidewall and/or in the housing base, with some embodiments. For ease of illustration, a single housing outlet 110 is depicted in the drawings. With some embodiments the housing outlet is located in a sidewall of the housing. With some further embodiments, housing outlet 110 is in fluid communication with a housing outlet pipe 111 that extends through housing sidewall 56.

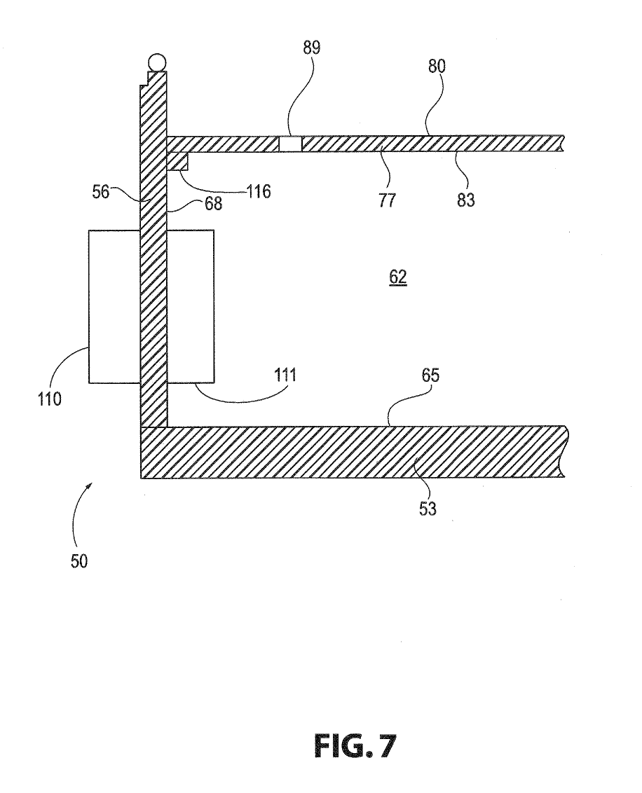

The support plate of the housing can be supported within the housing chamber of the housing by any suitable support system or combination of support systems, such as, but not limited to, one or more support members extending upward from the housing base (not shown). With some embodiments, an inner surface of the housing sidewall includes a support plate ledge, and the support plate resides on and is supported by the support plate ledge. With reference to FIG. 7, inner surface 68 of housing sidewall 56 has a support plate ledge 116 that extends outward therefrom into housing chamber 62, and support plate 77 resides on and is supported by support plate ledge 116. Second surface 83 of support plate 77 resides on or over support plate ledge 116. Support plate ledge 116 can be composed of a single annular support ledge or a plurality of suitably aligned support ledges that extend outward from inner surface 68 of housing sidewall 56. Support plate ledge 116 and support plate 77 can, with some embodiments, be attached together by one or more attachment systems, such as, but not limited to, fasteners, adhesives, welds, nut and bolt combinations, and/or snap fittings (not shown in the drawings).

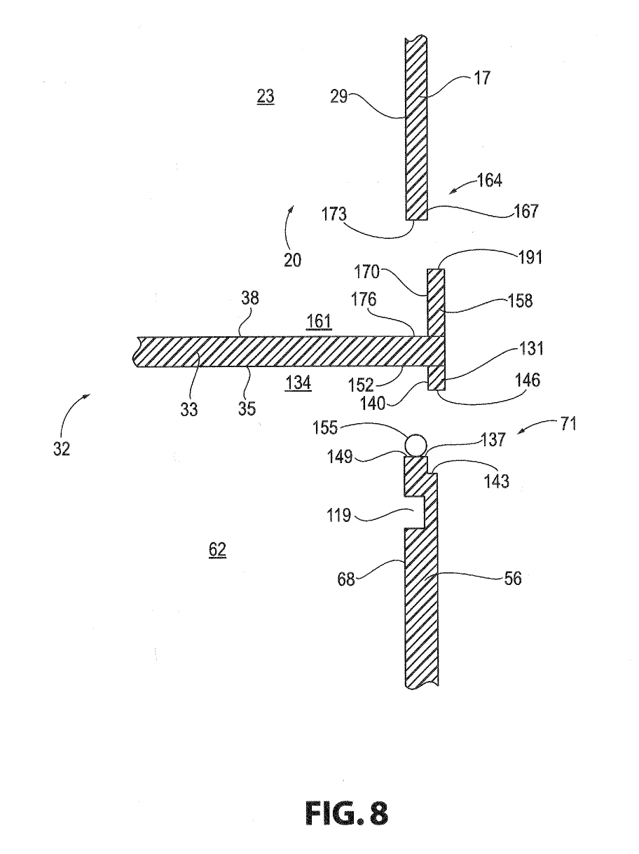

In accordance with some embodiments, an inner surface of the housing sidewall includes an annular groove, and a perimeter portion of the support plate resides within the annular groove, which results in the support plate being supported within the housing chamber. With reference to FIGS. 1(a), 1(b), and 8, inner surface 68 of housing sidewall 56 includes an annular groove 119, and a perimeter portion 122 of support plate 77 resides within and is supported by annular groove 119. With some embodiments, annular groove 119 includes a retention system (not shown) that serves to further retain perimeter portion 122 of support plate 77 therein, such as, but not limited to, an annular gasket, fasteners, and/or an adhesive.

The distributor head 95 of the nozzle 92 extends through both of the first support plate opening 86 and the first lid opening 41, such that the distributor head apertures 101 reside above second surface 38 of lid 32 and in fluid communication with container chamber 23, as described previously herein. With some embodiments the first lid opening and the first support plate opening are substantially aligned with each other. With some embodiments, first lid opening 41 and first support plate opening 86 are substantially vertically aligned with each other, as depicted in the drawings. With some further embodiments, the first lid opening and the second lid opening are aligned with each other along a line that is displaced from vertical by an angle of greater than 0° and less than 90°, such as from 30° to 60°.

In accordance with some embodiments, the first lid opening 41 and the first support plate opening 86 are each independently dimensioned so as to receive in each case distributor head 95 therethrough. With some embodiments, distributor head 95 is received abuttingly through first lid opening 41 and/or first support plate opening 86. With some further embodiments, distributor head 95 is received sealingly through and by first lid opening 41 and/or first support plate opening 86. With some additional embodiments, first lid opening 41 and/or first support plate opening 86 each independently include a gasket therein that is positioned abuttingly and sealingly against distributor head sidewall 98 (not shown). In accordance with some further embodiments, distributor head 95, and in particular distributor head sidewall 98, is free of abutting contact with any portion of first lid opening 41 and/or with first support plate opening 86.

The first lid opening has a size (such as a two-dimensional area) that is equal to or greater than the size (such as a two-dimensional area) of each second lid opening, and correspondingly each second lid opening independently has a size that is equal to or smaller than the size of the first lid opening. In accordance with some further embodiments, each second lid opening has a size that is substantially equivalent to the size of each other second lid opening. In accordance with some additional embodiments, at least one second lid opening has a size that is different than the size of at least one other second lid opening. With some embodiments, and for purposes of non-limiting illustration, the first lid opening is substantially circular and has a diameter of from 25 mm to 60 mm, or from 49.5 mm to 50.5 mm. With some further embodiments, and for purposes of non-limiting illustration, each second lid opening is substantially circular and independently has a diameter of from 6 mm to 60 mm, or from 49.5 mm to 50.5 mm.

The first support plate opening has a size (such as a two-dimensional area) that is greater than the size (such as a two-dimensional area) of each second support plate opening, and correspondingly each second support plate opening independently has a size that is less than the size of the first support plate opening, with some embodiments. In accordance with some further embodiments, each second support plate opening has a size that is substantially equivalent to the size of each other second support plate opening. In accordance with some additional embodiments, at least one second support plate opening has a size that is different than the size of at least one other second support plate opening. With some embodiments, and for purposes of non-limiting illustration, the first support plate opening is substantially circular and has a diameter of from 25 mm to 60 mm, or from 49.5 mm to 50.5 mm. With some further embodiments, and for purposes of non-limiting illustration, each second support plate opening is substantially circular and independently has a diameter of from 5 mm to 25 mm, or from 6 mm to 8 mm.

In accordance with some embodiments of the present invention, each second support plate opening is smaller than the first support plate opening, each second support plate opening is smaller than each second lid opening, and a total number of second support plate openings is greater than a total number of second lid openings. With reference to FIG. 2 and FIG. 3, and for purposes of non-limiting illustration, each second support plate opening 89 has a size that is smaller than the size of each second lid opening 44, and the total number of second support plate openings 89 (which is greater than 20) is greater than the total number of second lid openings 44 (which is 5). With some embodiments, the total number of second lid openings (such as second lid openings 44) is from 1 to 20, or from 2 to 10, or from 3 to 7. With some further embodiments, the total number of second support plate openings (such as second support plate openings 89) is from 10 to 200, or from 20 to 100, or from 25 to 95. With some additional embodiments, and as discussed previously herein, the total number of second support plate openings is greater than the total number of second lid openings.

The first lid opening can be positioned anywhere in the lid. With some embodiments, the lid has a geometric center, and the first lid opening (or the geometric center of the first lid opening) is positioned in (or at) the geometric center of the lid. With some further embodiments, the lid has a geometric center, and the first lid opening (or the geometric center of the first lid opening) has a position that is offset relative to the geometric center of the lid. As used herein, the term “offset” with regard to the first lid opening and the geometric center of the lid, means that the geometric center of the first lid opening has a position that is other than at the geometric center of the lid. With some embodiments, the first lid opening is offset relative to the geometric center of the lid, such that the first lid opening is free of overlap with the geometric center of the lid. At least some of the second lid openings can be positioned evenly or randomly in the lid, with some embodiments. With reference to FIG. 2, lid 32 has a geometric center 125, and first lid opening 41 has a position that is offset relative to geometric center 125 of lid 32, and first lid opening 41 is free of overlap with geometric center 125 of lid 32.

The first support plate opening can be positioned anywhere in the support plate. With some embodiments, the support plate has a geometric center, and the first support plate opening (or the geometric center of the first support plate opening) is positioned in (or at) the geometric center of the support plate. With some further embodiments, the support plate has a geometric center, and the first support plate opening (or the geometric center of the first support plate opening) has a position that is offset relative to the geometric center of the support plate. As used herein, the term “offset” with regard to the first support plate opening and the geometric center of the support plate, means that the geometric center of the first support plate opening has a position that is other than at the geometric center of the support plate. With some embodiments, the first support plate opening is offset relative to the geometric center of the support plate, such that the first support plate opening is free of overlap with the geometric center of the support plate. At least some of the second support plate openings can be positioned evenly or randomly in the support plate, with some embodiments. With reference to FIG. 3, support plate 77 has a geometric center 128, and first lid opening 86 has a position that is offset relative to geometric center 128 of support plate 77, and first support plate opening 86 is free of overlap with geometric center 128 of support plate 77.

In accordance with some embodiments of the present invention: (i) the lid has a geometric center, and the first lid opening is offset relative to the geometric center of the lid; (ii) the support plate has a geometric center, and the first support plate opening is offset relative to the geometric center of the support plate; and (iii) the first lid opening and the first support plate opening are substantially aligned with each other, such as, but not limited to, substantially vertically aligned with each other.

The lid and the housing of the chemical feeder are attached, such as reversibly attached, to each other with some embodiments of the present invention. As described previously herein an upper portion 71 of housing sidewall 56 is adapted to mate with a section 74 (such as, but not limited to, a perimeter section) of first surface 35 of lid 32.

In accordance with some embodiments, the lid includes a first rim that extends outward from the first surface of the lid, the first rim and the first surface of the lid together defining a lid outer recessed area, and the upper portion of the housing sidewall is received matingly and sealingly within the lid outer recessed area. Such a configuration serves to attach, such as reversibly attach, the lid and housing together. With reference to FIGS. 1(a), 1(b) and 2, lid 32 has a first rim 131 that extends outward from first surface 35 of lid 32. First rim 131 and first surface 35 of lid 32 together define a lid outer recessed area 134. Upper portion 71 of housing sidewall is received matingly and sealingly within lid outer recessed area 134.

With some embodiments, the mating engagement of the upper portion of the housing sidewall and the outer recessed area of the lid, involves an exterior surface of the upper portion of the housing sidewall abutting an inner surface of the first rim. With reference to FIG. 8, an exterior surface 137 of upper portion 71 of housing sidewall 56 abuts an inner surface 140 of first rim 131 of lid 32.

With some further embodiments, the mating engagement of the upper portion of the housing sidewall and the outer recessed area of the lid, further involves the exterior surface of the upper portion of the housing sidewall including a ledge that extends outward from the exterior surface of the upper portion of the housing sidewall, and an upper surface of the first rim and the outer ledge abutting each other. With further reference to FIG. 8, exterior surface 137 of upper portion 71 of housing sidewall 56 includes a ledge 143 that extends outward from exterior surface 137 of upper portion 71 of housing sidewall 56. An upper surface 146 of first rim 131 of lid 32 and outer ledge 143 abut each other. Ledge 143, with some embodiments, is an annular ledge that extends substantially around the whole of upper portion 71 of housing sidewall 56.

With some additional embodiments, and with further reference to FIG. 8, the mating engagement of the upper portion of the housing sidewall and the outer recessed area of the lid, further involves an upper surface 149 of upper portion 71 of housing sidewall 56 and a perimeter section 152 of first surface 35 of lid 32 (i) abutting each other, and/or (ii) engaging sealingly with each other. In accordance with some embodiments, a gasket 155 is interposed sealingly between upper surface 149 of upper portion 71 of housing sidewall 56 and a perimeter section 152 of first surface 35 of lid 32 (within lid outer recessed area 134). Gasket 155 can be an annular gasket, with some embodiments.

Lid 32 and upper portion 71 of housing sidewall 56 can be held together (such as in mating engagement) by suitable retaining systems. With some embodiments, lid 32 and upper portion 71 of housing sidewall 56 are held together by clamps, fasteners, pins, and/or adhesives (not shown). With some embodiments lid 32 and upper portion 71 of housing sidewall 56 are held together by releasable clamps or latches (not shown) that are anchored on the exterior surface of housing sidewall 56 and extend up to and releasably engage with a portion of lid 32, such as upper surface 191 of second rim 158 of lid 32 (see FIG. 8).

The lid of the chemical feeder, with some embodiments, is removably (or reversibly) attached to the open container end of the container. Removable/reversible attachment of the lid and the open container end of the container can be achieved by art-recognized systems, such as, but not limited to, threaded engagement there-between and/or snap-fitting engagement there-between (not depicted in the drawings). With reference to FIG. 8, and in accordance with some embodiments, lid 32 includes a second rim 158 that extends away from second surface 38 of lid 32 (or lid base 33). Second surface 38 and second rim 158 together define a lid inner recessed area 161. An upper portion 164 of container sidewall 17 is received matingly and sealingly within lid inner recessed area 161.

With some embodiments, the mating engagement of the upper portion of the container sidewall and the inner recessed area of the lid, involves an exterior surface of the upper portion of the container sidewall abutting an inner surface of the second rim. With reference to FIG. 8, an exterior surface 167 of upper portion 164 of container sidewall 17 matingly abuts an inner surface 170 of second rim 158 of lid 32. Exterior surface 167 of upper portion 164 of container sidewall 17 and inner surface 170 of second rim 158 of lid 32 have matching threaded portions (not shown) that serve to reversibly attach lid 32 and sidewall 17 of container 11 together, with some embodiments. Exterior surface 167 of upper portion 164 of container sidewall 17 and inner surface 170 of second rim 158 of lid 32 have reversibly engaging snap fittings (not shown) that serve to reversibly attach lid 32 and sidewall 17 of container 11 together, with some embodiments.

With some additional embodiments, and with further reference to FIG. 8, the mating engagement of the upper portion of the container sidewall and the inner recessed area of the lid, further involves an upper surface 173 of upper portion 164 of container sidewall 17 and a perimeter section 176 of second surface 38 of lid 32 (i) abutting each other, and/or (ii) engaging sealingly with each other. In accordance with some embodiments, a gasket (not shown) is interposed sealingly between upper surface 173 of upper portion 164 of container sidewall 17 and perimeter section 176 of second surface 38 of lid 32 (within lid inner recessed area 161). The gasket can be an annular gasket, with some embodiments.

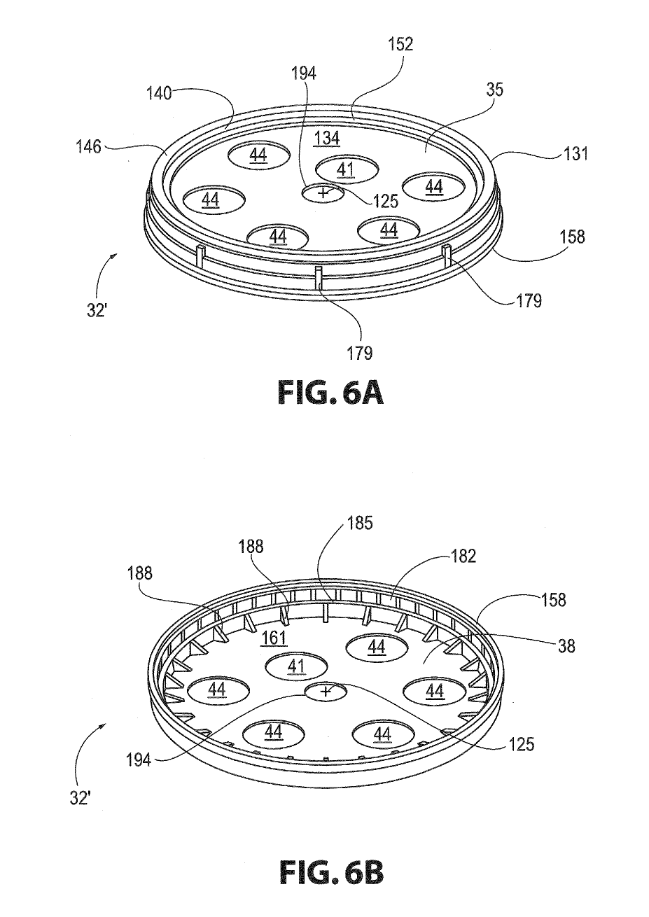

With reference to FIGS. 6(a) and 6(b) there is depicted a lid 32′, which is similar to lid 32. Lid 32′ includes a plurality of external reinforcing ribs 179 that extend between exterior surfaces of first rim 131 and a second rim 158. Lid 32 further includes an inner channel 182 that is defined by and resides between second rim 158 and third rim 185. Third rim 185 extends outward from second surface 38 of lid 32′ and is positioned inward relative to second rim 158. Inner channel 182 is dimensioned to receive therein upper portion 164 of container sidewall 17, with some embodiments. Upper portion 164 of container sidewall 17 can be received threadingly and/or snap fittingly within inner channel 182, in accordance with art-recognized threading and snap fitting systems. Threads (not shown) can be provided on interior surface 29 and/or exterior surface 167 of upper portion 164 of container sidewall 17 for purposes of being threadingly received within inner channel 182, with some embodiments. Inner channel 182 includes a gasket, such as an annular gasket, with some embodiments (not shown). Lid 32′ includes a plurality of inner reinforcing ribs 188 that extend between second surface 38 and third rim 185, with some embodiments. Lid 32′ also includes, with some embodiments, a center structure 194, which is nonfunctional and is a vestige of the injection molding process by which the lid can be produced. Structure 194 is not an aperture or opening.

The distributor head of the nozzle, with some embodiments, further includes a dome, the dome includes at least one dome hole, each dome hole resides above the second surface of the lid and in fluid communication with the container chamber, and each dome hole being adapted to distribute a feed liquid vertically into the container chamber. With reference to FIGS. 1(a) and 1(b), distributor head 95 includes a dome 197. Dome 197 includes at least one dome hole 200. Each dome hole 200 resides above second surface 38 of lid 32 and is in fluid communication with container chamber 23. Each dome hole 200 is adapted to distribute the feed liquid vertically into container chamber 23 as indicated by arrow 203. Each dome hole can independently have a shape selected from polygonal shapes, circular shapes, elliptical shapes, and combinations thereof. The dome of the distributor head can have any suitable configuration and shape. With some embodiments, the dome of the distributor head is substantially flat (as depicted in the drawings). With some further embodiments, the dome of the distributor head can have a shape selected from polygonal shapes, arcuate shapes, and combinations thereof (not shown) that, with some embodiments, extend into container chamber 23. With some embodiments, the dome of the distributor head is free of one or more dome holes. For purposes of non-limiting illustration, and in accordance with some embodiments, each dome hole is a substantially circular dome hole, and each independently has a diameter of from 10 mm to 25 mm, or from 10 mm to 13 mm.

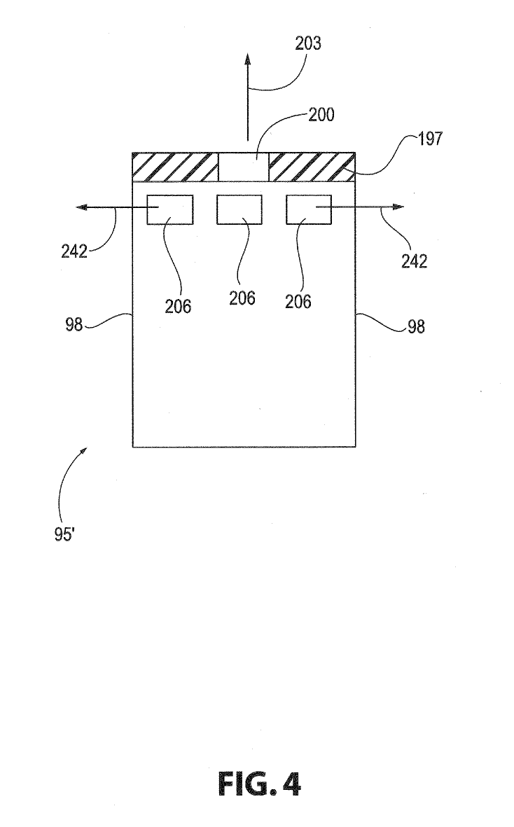

Each distributor head aperture of the distributor head of the nozzle can have any suitable shape. With some embodiments, each distributor head aperture independently has a shape selected from polygonal shapes, circular shapes, elliptical shapes, and combinations thereof. Distributor head apertures 101 have a substantially circular shape (see FIGS. 1(a) and 1(b)). With reference to FIG. 4, distributor head apertures 206 of distributor head 95′ each have a substantially rectangular shape. For purposes of non-limiting illustration, and in accordance with some embodiments, each distributor head aperture is substantially circular, and each independently has a diameter of from 10 mm to 25 mm, or from 10 mm to 15 mm.

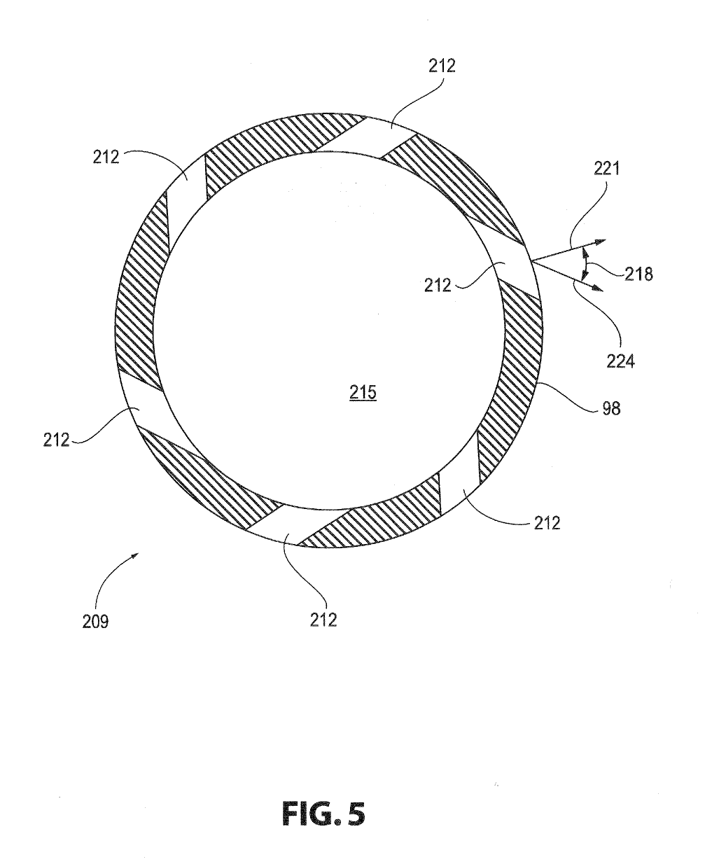

At least one distributor head aperture of the distributor head of the nozzle, with some embodiments, is a tangential distributor head aperture that is adapted to distribute liquid tangentially into the container chamber. For purposes of non-limiting illustration and with reference to FIG. 5, distributor head 209 includes a plurality of tangential distributor head apertures 212 that extend through distributor head sidewall 98. Each tangential distributor head aperture is in fluid communication with the distributor head interior space 215. With some embodiments and as depicted in FIG. 5, the tangential distributor head apertures are aligned so as to provide liquid exiting from the distributor head with a torsional or cyclonic motion. As used herein, the term “tangential distributor head aperture(s)” means a distributor head aperture that has an alignment angle 218 of greater than 0° and less than 90°. The alignment angle 218 is determined as between a reference line 221 extending directly out from the surface of the distributor head sidewall and an alignment line 224 of the tangential distributor head aperture. With some embodiments, when the distributor head has a substantially circular cross-section, reference line 221 corresponds to a radius line extending out from the center of the circular cross-section. Each tangential distributor head aperture independently has an alignment angle. With some embodiments, the alignment angles of at least two tangential distributor head apertures are different from each other. With some further embodiments, each alignment angle of each tangential distributor head aperture is the same.

The housing of the chemical feeder, with some embodiments, further includes an inlet pipe that provides fluid communication between the housing inlet and the nozzle. With reference to FIGS. 1(a) and 1(b), housing 50 includes an inlet pipe 227 that provides fluid communication between housing inlet 104 and nozzle 92. The inlet pipe can extend through any suitable portion of the housing, such as through the housing base or housing sidewall. As depicted in the drawings, and with some embodiments, inlet pipe 227 extends through housing sidewall 56.

In accordance with some embodiments and as depicted in the drawings, inlet pipe 227 has a first portion 230 having a first diameter, a second portion 233 that is flared, and a third portion 236 having a second diameter. First portion 230 extends through housing sidewall 56, second portion 233 and third portion 236 each reside within housing chamber 62, with some embodiments. Feed liquid introduced into housing inlet 104 passes in sequence through first portion 230, second portion 233, third portion 236, and into nozzle 92. The second diameter of third portion 236 is greater than the first diameter of first portion 230. Second portion 233, which is flared, has an initial diameter that is substantially equivalent to the first diameter of first portion 230, and a final diameter that is substantially equivalent to the second diameter of third portion 236, of inlet pipe 227, with some embodiments. With some embodiments, the increase in diameter of second portion 233 is substantially constant from the initial diameter to the final diameter thereof. The second diameter of third portion 236 is from 25% to 250%, such as from 30% to 150%, or from 50% to 100% greater than the first diameter of first portion 230 of inlet pipe 227, with some embodiments.

The nozzle further includes at least one nozzle drain hole that is located near the base of the nozzle, with some embodiments. The nozzle drain hole allows liquid to drain out of the nozzle when feed liquid is not being introduced into the housing inlet. With reference to FIGS. 1(a) and 1(b), nozzle 92 includes a nozzle drain hole 239, which is positioned near the base of nozzle 92, and near inner surface 65 of housing base 53. In accordance with some embodiments, the nozzle does not include a nozzle drain hole.

As described previously herein, a feed liquid is introduced into the chemical feeder through the housing inlet and a treated liquid including dissolved chemical material is removed from the chemical feeder through the housing outlet. In accordance with some embodiments, at least a portion of the feed liquid introduced through the housing inlet passes through the nozzle and laterally outward through each distributor head aperture into the container chamber where it contacts the solid chemical material, thereby forming a treated liquid including dissolved chemical material. With reference to FIGS. 1(a) and 1(b) and for purposes of non-limiting illustration, a feed liquid is introduced into housing inlet 104 as indicated by arrow 107. The feed liquid passes through inlet pipe 227 and into nozzle 92. The feed liquid passes up through nozzle 92 and into distributor head 95. With some embodiments, at least a portion of the feed liquid passing into (such as up into) distributor head 95 is distributed laterally outward through each distributor head aperture 101 (or 206, FIG. 4) as indicated by arrows 242 into container chamber 23 where it contacts solid chemical material 47. Contact of the feed liquid with solid chemical material 47 results in the formation of a treated liquid that includes dissolved chemical material, which passes from container chamber 23 through second lid openings 44, as indicated by arrow 245, into housing chamber 62, and then through second support plate openings 89 and further into housing chamber 62 as indicated by arrow 248, with some embodiments. The treated liquid that includes dissolved chemical material then passes from housing chamber 62 through housing outlet pipe 111 and is removed from chemical feed 3 through housing outlet 110, which some embodiments.

With some embodiments, and as described previously herein, the distributor head includes a dome, which optionally includes at least one dome hole. Correspondingly and with some embodiments, a further portion of the feed liquid passing into (such as up into) distributor head 95 is distributed vertically through each dome hole 200 and into container chamber 23, as indicated by arrow 203, where it contacts solid chemical material 47, and thereby forms a treated liquid that includes dissolved chemical material, which is removed from the chemical feed through housing outlet 110, as described above.

The present invention also relates to a method of forming a treated liquid that includes dissolved chemical material. The method includes providing the chemical feeder of the present invention, as described previously herein. The method further includes, introducing a feed liquid into the housing inlet, wherein the feed liquid passes through the nozzle and laterally outward through each distributor head aperture into the container chamber where it contacts the solid chemical material contained therein, thereby forming a treated liquid that includes dissolved chemical material. The method additionally includes: allowing the treated liquid that includes dissolved chemical material to pass from the container chamber through the plurality of second lid apertures and into the housing chamber; and removing, from the housing, the treated liquid that includes dissolved chemical material through the housing outlet.

The feed liquid introduced into the chemical feeder can be selected from any suitable liquid, or combination of liquids, in which at least a portion of the solid chemical material can be dissolved, with some embodiments. The liquid feed with some embodiments includes water and/or an organic liquid. Examples of organic liquids include, but are not limited to, alcohols, aldehydes, ketones, ethers, esters, carboxylic acids, carboxylic acid esters, aliphatic hydrocarbons, aromatic hydrocarbons, and combinations thereof. With some embodiments, the feed liquid includes water.

The solid chemical material, or treating agent, used with the chemical feeders and methods of the present invention can be any chemical that is solid at ambient (or standard) conditions of temperature and pressure (STP), and which is at least partially soluble, or readily soluble, in the feed liquid, such as water, that is introduced into the chemical feeder, at STP conditions. With some further embodiments, the solid chemical material is capable of being formed into pellets or tablets. The solid chemical material, with some further embodiments, is in the form of tablets that have a size, such as a diameter, which is greater than: (i) the size, such as the diameter, of the second lid openings (such as second lid openings 44); and (ii) the size, such as the diameter, of the second support plate openings (such as second support plate openings 89).

With some embodiments, the solid chemical material is selected from one or more nutrients, one or more sanitizing agents, one or more desanitizing agents, one or more pH control agents, and combinations thereof. In accordance with some further embodiments, the solid chemical material is selected from one or more pH control agents that include sodium bisulfate.

Examples of sanitizing agents, such as chemicals that sanitize water, from which the solid chemical material can be selected with some embodiments, include, but are not limited to, calcium hypochlorite, bromo-chloro hydantoins (such as, 1-bromo-3-chloro-5,5-dimethylhydantoin), dichlorohydantoins, chloroisocyanurates, and combinations thereof. Examples of desanitizing agents (such as dechlorination agents) from which the solid chemical material can be selected with some embodiments, include, but are not limited to, sodium sulfite, sodium metabisulfite, sodium bisulfite, sodium thiosulfate, sodium hydrosulfide (NaSH), and sodium sulfide (Na₂S). Examples of pH control agents from which the solid chemical material can be selected with some embodiments, include, but are not limited to, sodium bisulfate, citric acid, sodium carbonate, sodium bicarbonate, quaternary ammonium compounds, and combinations thereof. With some embodiments, at least some of the recited pH control agents can be used also as algaecides and/or antibacterial agents. Examples of nutrients from which the solid chemical material can be selected with some embodiments, include, but are not limited to, one or more fertilizers.

The chemical feeders of the present invention and as used with the methods of the present invention, with some embodiments, can be integrated into fluid, such as water, treatment operations by appropriate piping connected with housing inlet 104 and housing outlet 110. The chemical feeder can be integrated into, for example: a single pass system, such as an aqueous stream used to sanitize the surface of an article, such as vegetables, such as potatoes or surfaces used in the handling or processing of food; or a closed loop system, such as a swimming pool or hot tub. With some embodiments, the chemical feeder via housing inlet 104 and housing outlet 110, is connected directly (such as in-line) with the main fluid conduit used to recycle and treat fluid, such as water, from a stationary body of fluid, such as a swimming pool.

With some embodiments of the method of the present invention, the housing inlet of the chemical feeder is connected directly in-line with a main water conduit used to handle water withdrawn from a body of water. In this configuration, the outlet of the pump used to recycle the water is in direct fluid communication (by way of a suitable conduit) with the housing inlet of the chemical feeder, in which case the chemical feeder is located on the pressure side of the recycle pump. The pressure of the liquid stream (such as an aqueous stream) introduced into the housing inlet of the chemical feeder can vary widely, and is with some embodiments from 5 pounds per square inch (psi) (34 kilopascals) to 15 psi (103 kilopascals), or from 5 psi to 10 psi (69 kilopascals). The flow rate of the liquid stream (such as an aqueous stream) through the chemical feeder can also vary widely, and is, with some embodiments, from 2 to 100 gallons per minute (7.6 to 379 liters per minute), or from 5 to 75 gallons per minute (19 to 284 liters per minute), or from 10 to 50 gallons per minute (38 to 189 liters per minute).

The present invention also relates to a method of forming a treated liquid that includes dissolved chemical material that includes providing various parts of the chemical feed, assembling the various parts so as to form an assembled chemical feed, and then using the assembled chemical feeder to form a treated liquid that includes dissolved chemical material. The chemical feed can be assembled manually and/or mechanically. With some embodiments, the chemical feeder is assembled manually.

The method includes providing a container as described previously herein, which further includes a lid as described previously herein (which includes the first lid opening and plurality of second lid openings), which is attached to the open container end. The container includes a solid chemical material that is housed within the container chamber. The container can, with some embodiments, include one or more handles that are attached to the exterior surface of the container sidewall (not shown in the drawings). With some embodiments, the container, which includes the lid attached thereto, is transported and stored with the container base, such as container base 14, positioned on a support surface, such as the ground, a floor, a pallet, a shelf, or the first surface of the lid of an underlying container. As such, during transport and storage, the container sidewall extends upward from the container base, with some embodiments.

The method further includes providing a housing as described previously herein. The method additionally includes inverting the container (to which the lid is attached) and mounting the upper portion of the housing sidewall and a section (such as a perimeter section) of the first surface of the lid together, such that the distributor head extends through the first support plate opening and the first lid opening, and each distributor head aperture is positioned above the second surface of the lid and in fluid communication with the container chamber, each distributor head aperture being adapted to distribute a feed liquid laterally into the container chamber, wherein the support plate is positioned below the first surface of the lid, and wherein the plurality of second lid openings provide fluid communication between the container chamber and the housing chamber. As assembled, the chemical feed is as described previously herein.

After the chemical feeder has been assembled, the method further includes introducing the feed liquid into the housing inlet, wherein the feed liquid passes through the nozzle and laterally outward through each distributor head aperture into the container chamber where it contacts the solid chemical material, thereby forming the treated liquid that includes dissolved chemical material. The method additionally includes: allowing the treated liquid that includes dissolved chemical material to pass from the container chamber through the plurality of second lid apertures and into the housing chamber; and removing, from the housing, the treated liquid that includes dissolved chemical material through the housing outlet.

With some embodiments, prior to assembling the chemical feeder, the container has a solid lid attached to the open container end (not shown in the drawings). The solid lid is free of openings, such as the first lid opening and the plurality of second lid openings. In accordance with some embodiments, the method of the present invention further includes removing the solid lid from the open container end, and attaching the lid (which includes the first lid opening and plurality of second lid openings) to the open container end. After attaching the lid (which includes the first lid opening and plurality of second lid openings) to the open container end, the container is then inverted and mounted on the upper portion of the housing sidewall, as described previously herein.

With some embodiments, prior to assembly of the chemical feeder, the lid, which is attached to the open container end of the container, is adapted (i) to prevent the solid chemical material from passing out through the first lid opening and the plurality of second lid openings, and (ii) to prevent materials, such as moisture, from entering the container chamber, such as through the first lid opening and the plurality of second lid openings. In accordance with some embodiments of the present invention, the first lid opening includes a first lid opening closure, and each second lid opening independently includes a second lid opening closure, and the method further includes removing the first lid opening closure and removing each second lid opening closure prior to inverting the container and mounting the upper portion of the housing sidewall and the section of the first surface of the lid together.

The first lid opening closure and each second lid opening closure can each independently be selected from solid sheets (or solid films), and plugs. The solid sheets can be fabricated from any suitable material, such as organic polymer materials. The solid sheets can, with some embodiments, be removably attached over the first lid opening and/or the plurality of second lid openings by one or more adhesive layers interposed between the sheet and the first surface of the lid. The solid sheets can, with some embodiments, include one or more tabs that can be used to pull the solid sheets/solid films off of the first surface of the lid, thereby opening the underlying first/second lid opening.

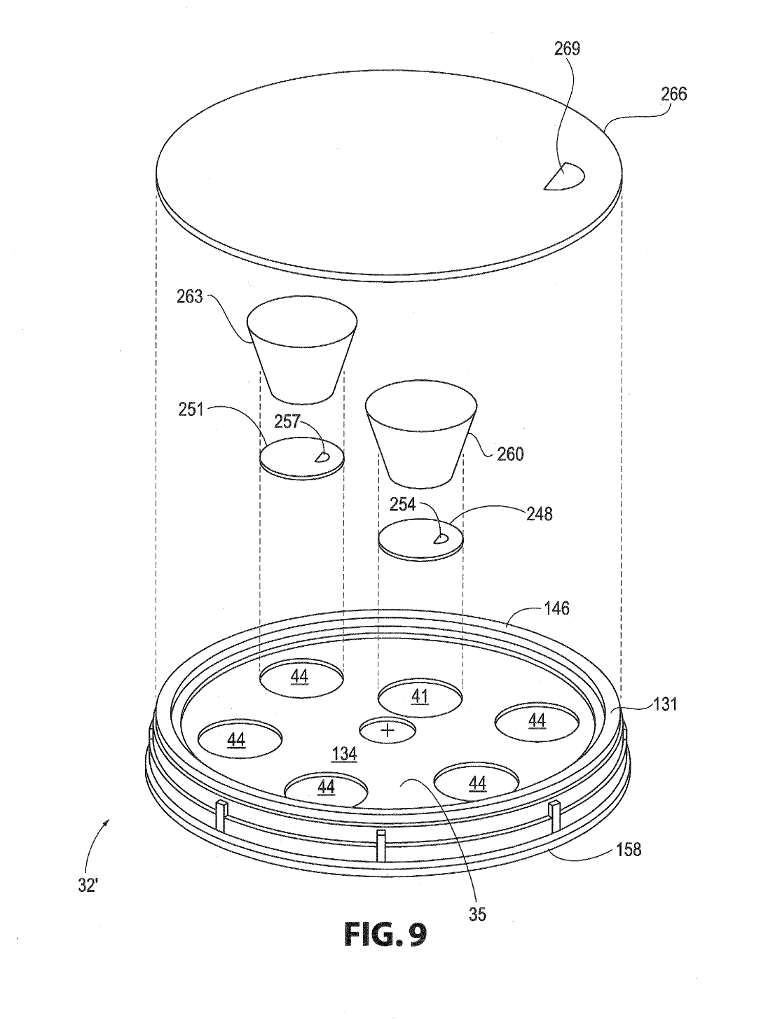

With reference to FIG. 9 lid 32′ includes a first lid opening closure, which is in the form of a first sheet 248 and a second lid opening closure, which in the form of a second sheet 251. First sheet 248 includes a tab 254, and second sheet 251 includes a tab 257. Tabs 254 and 257 are used, with some embodiments, to pull the respective sheet off and away from first surface 35 of lid 32′, so as to expose and open the underlying first or second lid opening, as the case may be. For ease of illustration, second lid opening closures are depicted for only a single second lid opening in FIG. 9.

In accordance with some embodiments of the present invention, the first lid opening closure is a first plug, and each second lid opening closure independently is a second plug. With reference to FIG. 9, and with some embodiments, the first lid opening closure is a first plug 260, and each second lid opening closure independently is a second plug 263. The first and second plugs are retained within the respective first and second lid openings by friction, with some embodiments. With some further embodiments, the first and second plugs are threadingly retained within the respective first and second lid openings. Examples of materials from which the first and second plugs can each be independently fabricated include, but are not limited to, wood, cork, ceramic, metal, and/or organic polymer materials.

In FIG. 9, while first sheet 248 and first plug 260, and second sheet 251 and second plug 263, are together depicted in exploded relationship with the respective first and second lid openings, with some embodiments, the plugs (260 and 263) and sheets (248 and 251) are not used together with the same lid opening. For example, and with some embodiments, first plug 260 or first sheet 248 are used to close first lid opening 41, and second plug 263 or second sheet 251 are independently used to close each second lid opening.

The lid, with some embodiments, further includes a lid cover that extends over and covers the first and second lid openings. The lid cover can be used in combination with or alternatively to the first and second lid opening closures. With some embodiments, the lid cover is used in combination with the first and second lid opening closures. The lid cover can be fabricated from any suitable material, such as wood, metal, and/or organic polymer materials. With some embodiments, the lid cover is in the form of a lid cover sheet. The lid cover can be attached to or over the first surface of the lid by art-recognized systems, such as fasteners, snap fittings, and/or adhesives. With reference to FIG. 9, lid 32′ further includes a lid cover 266, which can be removably attached to upper surface 146 of first rim 131 of lid 32′, such as by one or more adhesive layers (not shown). With some embodiments, lid cover 266 includes a tab 269 that can be used to assist in removing lid cover 266 from lid 32′.

The chemical feeders of the present invention and the various components thereof, such as the container, lid, housing, and support plate, can each be independently fabricated from any suitable material or combination of materials that are chemically and corrosion resistant to the solid chemical material and fluids (or liquids) used there-with. Examples of suitable fabrication materials include, but are not limited to, polyethylene, ABS (acrylonitrile-butadiene-styrene resin), fiberglass reinforced resins, polystyrene, polypropylene, poly(vinyl chloride), chlorinated poly(vinyl chloride) or any other appropriate material(s) that is chemically resistant to the solid chemical being dispensed, such as a sanitizing agent, such as calcium hypochlorite. Other materials such as stainless steel can additionally or alternatively be used, but the use of such materials would result in a significant increase in cost of the chemical feeder, with some embodiments. With some embodiments, the components of the chemical feeder, including the container, lid, housing, and support plate, are each independently fabricated from poly(vinyl chloride) (PVC), which is generally chemically resistant to water sanitizing chemicals, such as calcium hypochlorite. In accordance with some further embodiments of the present invention, at least a portion of the container sidewall (such as container sidewall 17) is fabricated from transparent or translucent PVC, or transparent or translucent polyethylene (PE), such as by injection molding, which allows for visual inspection of the amount of solid chemical material present in the container chamber (such as container chamber 23) without opening the container. Plastic parts of the chemical feeder and components thereof can be fabricated by art-recognized methods including, but not limited to, injection molding or rotational molding.

When constructed of plastic resin material, the various parts of the chemical feeder can, with some embodiments, be joined by solvent or heat welding or by threading. If a metal, such as stainless steel is used, conventional metal welding of the parts can be used to fabricate the chemical feeder and/or components thereof. Alternatively, the various components of the chemical feeder can be joined by conventional threaded bolts and appropriate gasketing to ensure that the chemical feeder is sealed, such as being liquid-tight, such as water-tight. Housing inlet 104 and housing outlet 110 can, with some embodiments, be joined to feed and removal conduits (not shown) by, for example, matched threaded sections, quick release fittings, plastic welding, and/or adhesives (not shown).

The various gaskets or seals, such as annular gaskets, used with the chemical feeder (such as with the lid, container, and/or housing) are, with some embodiments, fabricated from resilient materials that are resistant to the solid chemical materials and liquids used with the chemical feeder. Examples of materials from which the gaskets can be fabricated include, but are not limited to, rubber, such as natural rubber, styrene-butadiene rubber, neoprene rubber and silicone rubber; and fluorinated materials, such as homopolymers and copolymers of tetrafluoroethylene and chlorotrifluoroethylene, and copolymers of vinylidene fluoride and hexafluoropropylene.

Various modifications can be made to the chemical feeder of the present invention without departing from the spirit and scope thereof. For purposes of non-limiting illustration, the solid chemical materials can be contained within the container chamber in one or more canisters or baskets having a plurality of perforations therein, which allow for contact between the solid chemical material and feed liquid (or fluid) within the container chamber. The use of canisters or baskets, with some embodiments, can be advantageous when it is desirable to minimize direct contact of the solid chemical with the person who is placing it into the chamber. When one or more canisters are used to place solid chemical material within the container chamber of the chemical feeder, the container and canister can be together keyed or otherwise adapted to only allow the insertion of a specifically designed canister into the container chamber. Keying of the container and canisters can be used as a method of preventing the addition of incompatible chemical materials to the chamber, such as calcium hypochlorite and chloroisocyanurates. For example and with non-limiting reference to FIGS. 1(a) and 1(b), interior surface 29 of sidewall 17 of container 11 can be provided with a vertically elongated raised rectangular member (not shown) that mates slidingly with a matching vertically elongated female slot in the side of a canister that is placed within container chamber 23 (not shown). Such further non-limiting embodiments demonstrate that a wide variety of modifications can be made to the chemical feeder of the present invention without significantly affecting the operation thereof.

The present invention has been described with reference to specific details of particular embodiments thereof. It is not intended that such details be regarded as limitations upon the scope of the invention except insofar as and to the extent that they are included in the accompanying claims.

What is claimed is:

1. A chemical feeder comprising:
(a) a container comprising a container base, and a container sidewall extending downward from said container base, said container sidewall defining an open container end, said container base and said container sidewall together defining a container chamber;
(b) a lid attached to said open container end, said lid having a first surface, a second surface, a first lid opening, and a plurality of second lid openings, said lid being adapted to support a solid chemical material on and above said second surface of said lid and within said container chamber; and
(c) a housing comprising a housing base, and a housing sidewall extending upward from said housing base, said housing sidewall defining an open housing end, and said housing base and said housing sidewall together defining a housing chamber, wherein an upper portion of said housing sidewall is adapted to mate with a section of said first surface of said lid, said housing further comprising,
a support plate comprising a first support plate opening and a plurality of second support plate openings, said support plate residing within said housing chamber and being positioned above an interior surface of said housing base and below said first surface of said lid,
a nozzle that resides within said housing chamber, said nozzle comprising a distributor head comprising a distributor head sidewall comprising at least one distributor head aperture, wherein said distributor head extends through said first support plate opening and said first lid opening, and each distributor head aperture is positioned above said second surface of said lid and in fluid communication with said container chamber, each distributor head aperture being adapted to distribute a feed liquid laterally into said container chamber,
a housing inlet through which said feed liquid is introduced into said chemical feeder, said housing inlet being in fluid communication with said nozzle, wherein said plurality of second lid openings provide fluid communication between said container chamber and said housing chamber, and
a housing outlet that is in fluid communication with said housing chamber and through which said treated liquid comprising dissolved chemical material is removed from said housing.

2. The chemical feeder of claim 1, wherein an inner surface of said housing sidewall comprises a support plate ledge, and said support plate resides on said support plate ledge.

3. The chemical feeder of claim 1, wherein an inner surface of said housing sidewall comprises an annular groove, and a perimeter portion of said support plate resides within said annular groove.

4. The chemical feeder of claim 1, wherein said first lid opening and said first support plate opening are substantially aligned with each other.

5. The chemical feeder of claim 1, wherein each second support plate opening is smaller than said first support plate opening, each second support plate opening is smaller than each second lid opening, and a total number of second support plate openings is greater than a total number of second lid openings.

6. The chemical feeder of claim 1, wherein said lid has a geometric center, and said first lid opening is offset relative to said geometric center of said lid,
said support plate has a geometric center, and said first support plate opening is offset relative to said geometric center of said support plate, and
said first lid opening and said first support plate opening are substantially aligned with each other.

7. The chemical feeder of claim 1, wherein said lid comprises a first rim that extends outward from said first surface of said lid, said first rim and said first surface of said lid together defining a lid outer recessed area, and said upper portion of said housing sidewall being received matingly and sealingly within said lid outer recessed area.

8. The chemical feeder of claim 7, wherein an exterior surface of said upper portion of said housing sidewall abuts an inner surface of said first rim.

9. The chemical feeder of claim 8, wherein said exterior surface of said upper portion of said housing sidewall comprises a ledge that extends outward from said exterior surface of said upper portion of said housing sidewall, and an upper surface of said first rim and said outer ledge abut each other.

10. The chemical feeder of claim 1, wherein said distributor head further comprises a dome, said dome comprising at least one dome hole, each dome hole residing above said second surface of said lid and in fluid communication with said container chamber, and each dome hole being adapted to distribute said feed liquid vertically into said container chamber.

11. The chemical feeder of claim 1, wherein said lid is removably attached to said open container end.

12. The chemical feeder of claim 1, wherein said housing further comprises an inlet pipe that provides fluid communication between said housing inlet and said nozzle.

13. The chemical feeder of claim 1, wherein said container is a substantially cylindrical container, and said housing is a substantially cylindrical housing.

14. The chemical feeder of claim 1, wherein at least one distributor head aperture is a tangential distributor head aperture that is adapted to distribute liquid tangentially into said container chamber.

15. The chemical feeder of claim 1, wherein at least a portion of said feed liquid introduced through said housing inlet passes through said nozzle and laterally outward through each distributor head aperture into said container chamber where it contacts said solid chemical material thereby forming said treated liquid comprising dissolved chemical material.

16. A method of forming a treated liquid comprising dissolved chemical material comprising:
(a) providing a chemical feeder comprising,
a container comprising a container base, and a container sidewall extending downward from said container base, said container sidewall defining an open container end, said container base and said container sidewall together defining a container chamber,
(ii) a lid attached to said open container end, said lid having a first surface, a second surface, a first lid opening, and a plurality of second lid openings, said lid being adapted to support a solid chemical material on and above said second surface of said lid and within said container chamber, and
(iii) a housing comprising a housing base, and a housing sidewall extending upward from said housing base, said housing sidewall defining an open housing end, and said housing base and said housing sidewall together defining a housing chamber, wherein an upper portion of said housing sidewall is adapted to mate with a section of said first surface of said lid, said housing further comprising,
a support plate comprising a first support plate opening and a plurality of second support plate openings, said support plate residing within said housing chamber and being positioned above an interior surface of said housing base and below said first surface of said lid,
a nozzle that resides within said housing chamber, said nozzle comprising a distributor head comprising a distributor head sidewall comprising at least one distributor head aperture, wherein said distributor head extends through said first support plate opening and said first lid opening, and each distributor head aperture is positioned above said second surface of said lid and in fluid communication with said container chamber, each distributor head aperture being adapted to distribute a feed liquid laterally into said container chamber,
a housing inlet that is in fluid communication with said nozzle, wherein said plurality of second lid openings provide fluid communication between said container chamber and said housing chamber, and
a housing outlet that is in fluid communication with said housing chamber;
(b) introducing said feed liquid into said housing inlet, wherein said feed liquid passes through said nozzle and laterally outward through each distributor head aperture into said container chamber where it contacts said solid chemical material, thereby forming said treated liquid comprising dissolved chemical material;
(c) allowing said treated liquid comprising dissolved chemical material to pass from said container chamber through said plurality of second lid apertures and into said housing chamber; and
(d) removing, from said housing, said treated liquid comprising dissolved chemical material through said housing outlet.

17. The method of claim 16, wherein said feed liquid comprises water.

18. The method of claim 16, wherein said solid chemical material is selected from one or more nutrients, one or more sanitizing agents, one or more desanitizing agents, and one or more pH control agents.

19. The method of claim 18, wherein said solid chemical material is selected from one or more pH control agents comprising sodium bisulfate.

20. A method of forming a treated liquid comprising dissolved chemical material comprising:
(a) providing a container comprising a container base, and a container sidewall extending upward from said container base, said container sidewall defining an open container end, said container base and said container sidewall together defining a container chamber in which a solid chemical material is housed, said container further comprising a lid attached to said open container end, said lid having a first surface, a second surface, a first lid opening, and a plurality of second lid openings, said lid being adapted to support said solid chemical material on and above said second surface of said lid and within said container chamber;
(b) providing a housing comprising a housing base, and a housing sidewall extending upward from said housing base, said housing sidewall defining an open housing end, and said housing base and said housing sidewall together defining a housing chamber, wherein an upper portion of said housing sidewall is adapted to mate with a section of said first surface of said lid, said housing further comprising,
a support plate comprising a first support plate opening and a plurality of second support plate openings, said support plate residing within said housing chamber and being positioned above an interior surface of said housing base,
a nozzle that resides within said housing chamber, said nozzle comprising a distributor head comprising a distributor head sidewall comprising at least one distributor head aperture,
a housing inlet that is in fluid communication with said nozzle, and
a housing outlet that is in fluid communication with said housing chamber;
(c) inverting said container and mounting said upper portion of said housing sidewall and said section of said first surface of said lid together, such that said distributor head extends through said first support plate opening and said first lid opening, and each distributor head aperture is positioned above said second surface of said lid and in fluid communication with said container chamber, each distributor head aperture being adapted to distribute a feed liquid laterally into said container chamber, wherein said support plate is positioned below said first surface of said lid, and wherein said plurality of second lid openings provide fluid communication between said container chamber and said housing chamber;
(d) introducing said feed liquid into said housing inlet, wherein said feed liquid passes through said nozzle and laterally outward through each distributor head aperture into said container chamber where it contacts said solid chemical material, thereby forming said treated liquid comprising dissolved chemical material;
(e) allowing said treated liquid comprising dissolved chemical material to pass from said container chamber through said plurality of second lid apertures and into said housing chamber; and
(f) removing, from said housing, said treated liquid comprising dissolved chemical material through said housing outlet.

21. The method of claim 20, wherein said first lid opening comprises a first lid opening closure, and each second lid opening comprises a second lid opening closure, said method further comprising removing said first lid opening closure and each second lid opening closure prior to inverting said container and mounting said upper portion of said housing sidewall and said section of said first surface of said lid together.

22. The method of claim 21, wherein said first lid opening closure is a first plug, and each second lid opening closure independently is a second plug.
